(19) United States
(12) Patent Application Publication
(10) Pub. No.: US 2026/0298263 A1
(43) Pub. Date: Oct. 1, 2026

(54) Pump Assembly

(71) Applicant: KSB SE & Co. KGaA, Frankenthal (DE)

(72) Inventors: Julien BLAISE, Frankenthal (DE); Uwe BRUHNS, Frankenthal (DE); Armin GAISER, Frankenthal (DE); Ralf GRABER, Frankenthal (DE); Richard MAIWALD, Frankenthal (DE); Sven OBERHOLZ, Frankenthal (DE)

(21) Appl. No.: 18/998,234

(22) PCT Filed: Jul. 6, 2023
(86) PCT No.: PCT/EP2023/068714

§ 371 Date: Jan. 24, 2025

(30) Foreign Application Priority Data
Jul. 25, 2022 (DE) 10 2022 118 510.9

(51) Int. Cl. F04D 29/42; F04D 1/00; F04D 29/02; F04D 29/22

(52) U.S. Cl. CPC F04D 29/426; F04D 1/00; F04D 29/026; F04D 29/22

(57) ABSTRACT

A centrifugal pump assembly includes a hydraulic casing, a suction port, a pressure port, a flow chamber, a casing cover, an impeller, and an inflow nozzle having a first end and a second end. A radial annular gap is produced between the portion of the inflow nozzle and the hydraulic casing in a region of the recess. The portion is divided into a first sub-portion and a second sub-portion, which is close to the free end, and the second sub-portion comprises a sleeve-like or ring-like expansion element in the region of the free end. A material of the expansion element has a higher coefficient of thermal expansion than a material of the hydraulic casing.

### CROSS REFERENCE TO RELATED APPLICATION

This application claims priority under 35 U.S.C. § 119 from German Patent Application No. 1020221185109, filed Jul. 25, 2022, the entire disclosure of which is herein expressly incorporated by reference.

### BACKGROUND

The disclosure relates to a pump assembly, in particular a centrifugal pump assembly, comprising: a hydraulic casing; a suction port, which is formed on the hydraulic casing and has an inlet opening; a pressure port, which is formed on the hydraulic casing and has an outlet opening; a flow chamber, which is at least partially delimited by the hydraulic casing; a casing cover, which closes the hydraulic casing; an impeller, which is arranged in the flow chamber and can be driven about an axis of rotation via a shaft; and an inflow nozzle having a first end, which is connected indirectly or directly to the hydraulic casing, and a substantially cylindrical portion, which extends coaxially with the axis of rotation toward the inlet opening, wherein a second, free end opposite the first end is arranged in a recess of the inlet opening at the transition from the inlet opening to the flow chamber, and a radial annular gap is produced between the portion of the inflow nozzle and the hydraulic casing in the region of the recess.

Such pump assemblies are used, for example, in nuclear main coolant pumps.

The free end of the inflow nozzle and the hydraulic casing form an annular gap, which connects the high-pressure region and the low-pressure region of the pump. The pressure difference between the high-pressure region and the low-pressure region results in a volumetric flow through this gap, which leads to volumetric losses and thus to a reduced efficiency of the pump. These volumetric losses depend on the pressure difference and the gap width between the casing and the inflow nozzle. A certain radial annular gap between these two parts is unavoidable to allow installation of the inflow nozzle. In addition, the gap is enlarged during hot operation as a result of the expansion of the hydraulic casing owing to internal pressure and temperature. This leads to increased volumetric losses through this gap during hot operation and thus to a reduced efficiency. The aim of the present disclosure is to minimize the annular gap, in particular the radial gap width, during hot operation and thus to reduce the volumetric losses and to increase the efficiency of the pump. This shall take into account the fact that a certain gap at ambient temperature is still necessary for installation reasons.

### SUMMARY

The present disclosure is based on the object of mitigating or even entirely eliminating the defects of the devices known from the prior art. Specifically, an object of the present disclosure is to provide a pump assembly in which the enlargement of the gap as a result of pressure and temperature during hot operation of the pump is reduced and the efficiency of the pump is increased.

This object is achieved by a pump assembly having the feature of claim 1 according to which the cylindrical portion is divided into a first sub-portion and a second sub-portion, which is close to the free end, and the second sub-portion comprises a sleeve-or ring-like expansion element in the region of the free end, wherein the material of the expansion element has a higher coefficient of thermal expansion than the material of the hydraulic casing.

To safely reduce or completely close the annular gap, it has proven particularly advantageous when the material of the expansion element comprises austenitic steel. The austenitic material has a high coefficient of expansion and at the same time good resistance to the conveyed medium.

A simple and operationally reliable embodiment can be obtained by welding the expansion element and the first sub-portion to one another, wherein the material of the expansion element has a higher coefficient of expansion than the hydraulic casing.

So that an exact alignment of the first sub-portion with the second sub-portion without a substantial step is possible during operation, and the inner lateral face of the expansion element and the inner lateral face of the first sub-portion are substantially flush in a manner favorable to flow, the expansion element preferably has a contact face that faces the first sub-portion and comprises an axial annular elevation and an axial offset.

In addition, the first sub-portion has a contact face that faces the expansion element and is at least partially complementary to the contact face of the expansion element.

In an alternative embodiment, the second sub-portion close to the free end comprises, in the region of the free end, the sleeve-or ring-like expansion element and a holding device at least partially surrounding the expansion element.

Advantageously, the holding device is formed integrally with the first sub-portion for an operationally reliable structure, and the expansion element is arranged in the holding device.

The material of the holding device advantageously has a lower coefficient of expansion than the material of the sleeve-or ring-like expansion element. As a result, the holding device is stretched outward via the sleeve-or ring-like expansion element at higher temperatures owing to the higher coefficient of expansion of the sleeve-or ring-like expansion element, and thus the gap from the hydraulic casing is reduced or closed.

For simple installation and safe operation, the expansion element and the holding device are connected to one another by means of a shrink fit. The use of a welding method can thus be dispensed with.

So that the radial annular gap can be safely closed during hot operation, the holding device advantageously has a region with an enlarged internal diameter such that the holding device has flexibility in the radial direction.

Further advantages, features and effects of the present disclosure can be found in the figures below. In the figures,

### BRIEF DESCRIPTION OF THE DRAWINGS

FIG. 1 shows a longitudinal section through a pump assembly having an inflow nozzle according to the prior art,

FIG. 2 shows a longitudinal section through an embodiment of the inflow nozzle according to the disclosure, and

FIG. 3 shows a longitudinal section through an embodiment of the inflow nozzle according to the disclosure.

### DETAILED DESCRIPTION

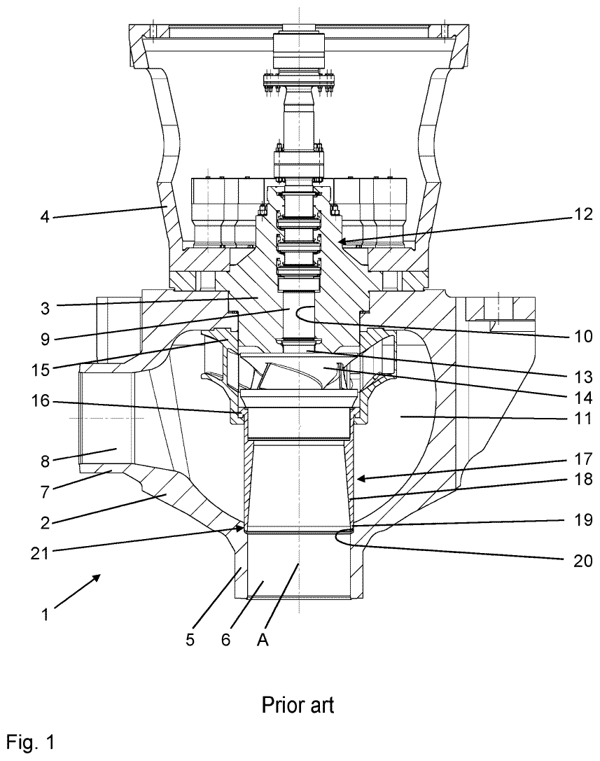

FIG. 1 shows a pump assembly 1 in the form of a main coolant pump assembly according to the prior art. The pump assembly 1 has a casing part designed as a hydraulic casing 2, as well as a casing cover 3 and a lantern 4.

The hydraulic casing 2 has an inlet opening 6 at a suction port 5 in order to suck in a conveyed medium and an outlet opening 8 at a pressure port 7 in order to eject the conveyed medium. The casing cover 3 is arranged on the side of the hydraulic casing 2 opposite the inlet opening 6. The lantern 4 is fastened to the side of the casing cover 3 facing away from the hydraulic casing 2. A motor (not shown) is connected to the hydraulic casing 2 by means of the lantern.

A shaft 9, which is rotatable about an axis of rotation A and is designed in multiple parts in the embodiment shown by way of example, extends from the motor (not shown) through an opening 10 provided in the casing cover 3, into a flow chamber 11 delimited by means of the hydraulic casing 2 and the casing cover 3.

A bearing device (not shown) for supporting the shaft 9 is provided in the opening 10. The flow chamber 11 is sealed against leaking into the lantern 4 using seal packing 12, which comprises multiple seal devices arranged one behind the other in the axial direction.

An impeller 14 is fastened to an end 13 of the shaft 9, said end lying inside the flow chamber 11. In the exemplary embodiment, on the side opposite the suction port 5 and inlet opening 6, a guide wheel 15, which surrounds the impeller 14, is arranged on or fastened to the hydraulic casing 2 in a rotationally fixed and axially non-displaceable manner. The guide wheel 15 ensures that the swirled flow emerging from the impeller 14 is deflected into a swirl-free flow with the lowest losses possible, wherein the magnitude of the absolute velocity is reduced and the static pressure is increased.

An inflow nozzle 17 is fastened by a first end 16 to the guide wheel 15. The inflow nozzle 17 has a substantially cylindrical portion 18, which extends coaxially with the axis of rotation A toward the inlet opening 6. A second, free end 19 opposite the first end 16 is arranged in a recess 20 of the inlet opening 6, that is, a region with an enlarged internal diameter, at the transition from the inlet opening 6 to the flow chamber 11. A radial annular gap 21 is produced in the region of the enlarged internal diameter between the portion 18 close to the region of the free end 19 of the inflow nozzle 17 and the hydraulic casing 2.

In a further embodiment (not shown), the inflow nozzle 17 and the guide wheel 15 can be designed as a single-part or integral component.

Instead of an inflow nozzle 17 connected to the hydraulic casing 2 indirectly via the guide wheel 15 and the casing cover 3, an inflow nozzle 17 that is connected to the hydraulic casing 2 directly can also be provided.

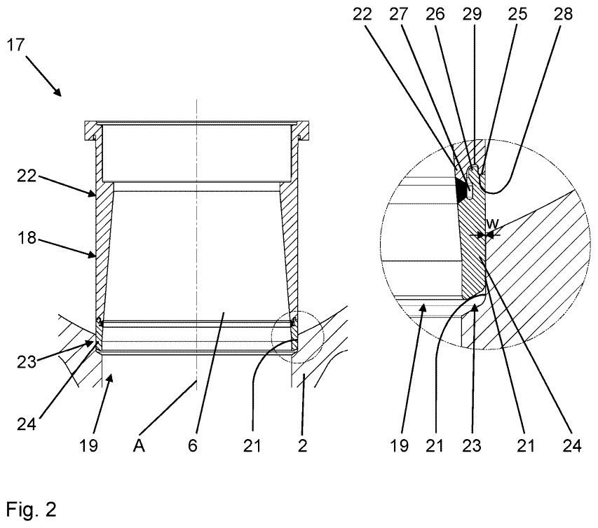

FIG. 2 shows the arrangement of the free end 19 of a first embodiment according to the disclosure of the inflow nozzle 17 in the recess 20, wherein the left-hand region of FIG. 2 shows the complete inflow nozzle 17, and the right-hand region shows substantially the free end 19 of same. The portion 18 is divided into a first sub-portion 22 and a second sub-portion 23 close to the free end 19. In the region of the free end 19, the second sub-portion 23 comprises a sleeve-or ring-like expansion element 24. The expansion element 24 and the first sub-portion 23 are welded to one another. The inner lateral face of the expansion element 24 and the inner lateral face of the first sub-portion 22 of the portion 18 are substantially flush. The material of the expansion element 24 has a higher coefficient of thermal expansion than the material of the hydraulic casing 2 and/or of the portion 18. The expansion element 24 has a contact face 25 that faces the first sub-portion 22 and comprises an annular axial elevation 26 and an axial offset 27. The first sub-portion 22 has a contact face 28 that faces the expansion element 24 and is at least partially complementary to the contact face 25 of the expansion element 24. In particular, the contact face 28 has a groove 29, in which the elevation 26 engages.

An exact alignment of the second sub-portion 23 or the expansion element 24 with the first sub-portion 22 without a substantial step is thus possible during operation. The inner lateral face of the expansion element 24 and the inner lateral face of the first sub-portion 22 are substantially flush in a manner favorable to flow.

The welding can be a partial welding, as shown in FIG. 2, or a continuous welding over the full radial extent of the sub-portion 23.

The annular gap 21, which has a radial gap width w, is designed such that, in the cold state of the centrifugal pump 1, it is possible for the conveyed medium to flow back via the annular gap 21 into the inlet opening 6, therefore from the high-pressure region via the annular gap 21 into the low-pressure region. During operation with a usually hot conveyed medium, the free end 19, in particular the expansion element 24, expands. Since the material of the expansion element 24 has a higher coefficient of thermal expansion than the material of the hydraulic casing 2, the expansion element 24, in particular as a result of its expansion in the radial direction, in the recess 20 of the inlet opening 6 comes into contact with the hydraulic casing 2 or at least reduces the annular gap 21 in the radial direction.

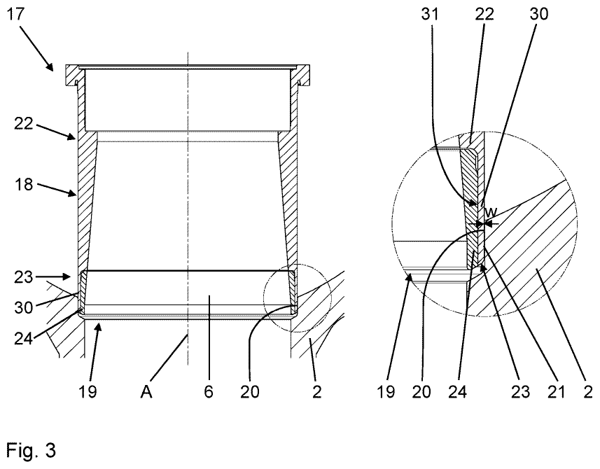

FIG. 3 shows a further embodiment according to the disclosure of the inflow nozzle 17. The left-hand region of FIG. 3 shows the complete inflow nozzle 17, and the right-hand region shows substantially the free end 19 of the inflow nozzle 17. The second sub-portion 23 close to the free end 19 comprises, in the region of the free end 19, the sleeve-or ring-like expansion element 24 and a holding device 30 at least partially surrounding the expansion element 24. The holding device 30 is formed integrally with the first sub-portion 22 and thus forms a region with an enlarged internal diameter. The expansion element 24 is arranged in the holding device 30. The expansion element 24 and the holding device 30 are connected to one another by means of a shrink fit. In this embodiment too, the inner lateral face of the expansion element 24 and the inner lateral face of the first sub-portion 22 of the portion 18 are substantially flush. The material of the expansion element 24 has a higher coefficient of thermal expansion than the material of the hydraulic casing 2 and of the holding device 30. The holding device 30 has a region 31 with an enlarged internal diameter so that the holding device 30 has a certain flexibility in the radial direction.

During operation with a hot conveyed medium, the expansion element 24 expands. As a result of its radial expansion component, the expansion element 24 brings the flexibly arranged holding device 30 in the recess 20 of the inlet opening 6 into contact with the hydraulic casing 2 or at least reduces the annular gap 21, in particular the radial gap width w, in the radial direction.

Thanks to the described embodiments of the inflow nozzle 17, the volumetric losses are reduced and the efficiency of the pump is increased during hot operation by the narrowing or closing of the annular gap 21. The expansion element 24 preferably comprises austenitic steel.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1-9. (canceled)

10. A centrifugal pump assembly, comprising:
a hydraulic casing;
a suction port, which is formed on the hydraulic casing and has an inlet opening;
a pressure port, which is formed on the hydraulic casing and has an outlet opening;
a flow chamber, which is at least partially delimited by the hydraulic casing;
a casing cover, which closes the hydraulic casing;
an impeller, which is arranged in the flow chamber and is drivable about an axis of rotation via a shaft; and
an inflow nozzle having a first end, which is connected indirectly or directly to the hydraulic casing, and a substantially cylindrical portion, which extends coaxially with the axis of rotation toward the inlet opening, wherein
a second, free end opposite the first end is arranged in a recess of the inlet opening at the transition from the inlet opening to the flow chamber,
a radial annular gap is produced between the portion of the inflow nozzle and the hydraulic casing in a region of the recess,
the portion is divided into a first sub-portion and a second sub-portion, which is close to the free end, and the second sub-portion comprises a sleeve-like or ring-like expansion element in the region of the free end, and
a material of the expansion element has a higher coefficient of thermal expansion than a material of the hydraulic casing.

11. The centrifugal pump assembly as claimed in claim 10, wherein the material of the expansion element comprises austenitic steel.

12. The centrifugal pump assembly as claimed in claim 11, wherein the expansion element and the first sub-portion are welded to one an-other.

13. The centrifugal pump assembly as claimed in claim 12, wherein the expansion element has a contact face that faces the first sub-portion and comprises an annular axial elevation and an axial offset.

14. The centrifugal pump assembly as claimed in claim 13, wherein the first sub-portion has a contact face that faces the expansion element and is at least partially complementary to the contact face of the expansion element.

15. The centrifugal pump assembly as claimed in claim 11, wherein the second sub-portion close to the free end comprises, in a region of the free end, the sleeve-like or ring-like expansion element and a holding device at least partially surrounding the expansion element.

16. The centrifugal pump assembly as claimed in claim 15, wherein the holding device is formed integrally with the first sub-portion, and the expansion element is arranged in the holding device.

17. The centrifugal pump assembly as claimed in claim 16, wherein the expansion element and the holding device are connected to one another via a shrink fit.

18. The centrifugal pump assembly as claimed in claim 17, wherein the holding device has a region with a reduced internal diameter such that the holding device has flexibility in a radial direction.
